(19) United States
(12) Patent Application Publication
(10) Pub. No.: US 2016/0032566 A1
(43) Pub. Date: Feb. 4, 2016

(54) HYDRAULIC SECTION FOR LOAD SENSING APPLICATIONS AND MULTIPLE HYDRAULIC DISTRIBUTOR

(71) Applicant: BUCHER HYDRAULICS S.P.A, REGGIO EMILIA (RE) (IT)

(72) Inventors: LUCA TADDIA, MODENA (IT); MASSIMO RIVA, MODENA (IT)

(21) Appl. No.: 14/809,620

(22) Filed: Jul. 27, 2015

(30) Foreign Application Priority Data
Jul. 31, 2014 (EP) 14179398.4

(51) Int. Cl. E02F 9/22; F15B 11/16

(52) U.S. Cl. CPC E02F 9/2228; F15B 11/162; F15B 11/166

(57) ABSTRACT

Hydraulic section (1) for use in a hydraulic distributor (10) comprising:
a valve body (2) with a main spool (3);
a piston (11);
a flow regulating element (21) receiving the hydraulic fluid coming from a front chamber (30), the piston (11) having a head (12a) of the stem (12) engaged in the flow regulating element (21);
an intermediate chamber (16) delimited by the stem (12) of the piston (11); control means (6, 7, 18) operatively active on the intermediate chamber (16) to alter its pressure so that the combined piston (11)—regulating element (21) system goes from a balance condition, in which the regulating element (21) is inactive, and a decoupling condition, in which the pressure of the front chamber (30) is decoupled from the pressure of the intermediate chamber (16).

The present invention relates to a hydraulic section for load sensing applications, and a multiple hydraulic distributor using one or more of such hydraulic sections.

As is known, a load sensing hydraulic system enables the pressure drop to be kept substantially constant through a metering orifice of a spool valve. In particular, a load sensing hydraulic system can be used in operating machines that envisage the simultaneous implementation of a plurality of movements. For example, consider an operating machine with a rotating turret, such as an excavator or a telescopic loader, wherein the rotation of the cab, the extraction of the jib and the movements of the bucket need to be handled independently from one another.

In a load sensing hydraulic system of the traditional type, demand for a higher flow than the maximum deliverable by the pump is followed by the slowing or stopping of the user with the highest load. This situation is is particularly critical in the case quoted above of the operating machine with a rotating turret since the rotation of the cab, the extraction of the jib, or the movement of the bucket could suddenly stop.

To overcome the limits of traditional architectures flow-sharing architectures have been developed in which demand for higher flow than the maximum deliverable by the pump is followed by a proportional reduction in flow for all users.

However, there are applications where the proportional reduction of the flow of some users could compromise the correct operation of the machine. In such circumstances, the critical user is given priority over the others through the use of a dedicated priority section.

A priority section means a section which, under flow saturation conditions, does not participate in the proportional reduction in delivered flow but maintains a constant flow, forcing the other sections to further reduce their flow.

European patent application 14158991.1 is an example of this, filed on Nov. 3, 2014 by the Applicant.

Such patent application discloses a hydraulic section wherein the local compensator is coupled to a differential piston, i.e. a piston that can be piloted by altering the pressure exerted on some active areas of the piston (front active area, rear active area and lateral or intermediate active area). The concept of a differential piston, which is applicable both in a flow-sharing hydraulic section and a priority hydraulic section, enables the maximum working pressure to be controlled locally with minimal power dissipation, reducing the energy consumption of the system.

The hydraulic section proposed in European patent application no. 14158991.1 is therefore compact, structurally simple and extremely versatile since the concept of differential piston is applicable both in flow-sharing and priority sections.

However, such a solution does not fully resolve the requirement to regulate the power dispensed to uses according to external signals (e.g. alarm) or to limit the speed of a user upon reaching a predefined pressure value (also internal signal) in order to make an energy saving and optimise the exploitation of power.

In this context, the technical task underpinning the present invention is to provide a hydraulic section for load sensing applications and a multiple hydraulic distributor, which obviate the drawbacks of the prior art cited above.

In particular, the object of the present invention is to provide a hydraulic section for load sensing applications that can regulate the flow to the uses according to external signals or pre-established internal signals.

Another object of the present invention is to propose a multiple hydraulic distributor comprising a plurality of structurally similar hydraulic sections.

The technical task set and the object specified are substantially attained by a hydraulic section for load sensing applications and a multiple hydraulic distributor, comprising the technical characteristics as set out in one or more of the accompanying claims.

Further characteristics and advantages of the present invention will become more apparent from the following indicative, and hence non-limiting, description of a preferred, but not exclusive, embodiment of a hydraulic section for load sensing applications and a multiple hydraulic distributor as illustrated in the appended drawings, in which:

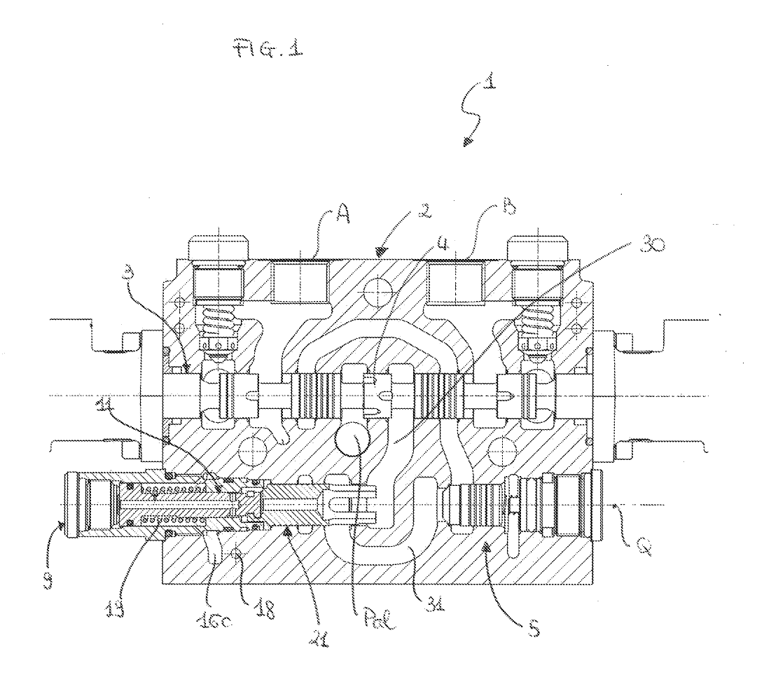

FIG. 1 illustrates a hydraulic section for use in a hydraulic distributor, according to the present invention, in section view;

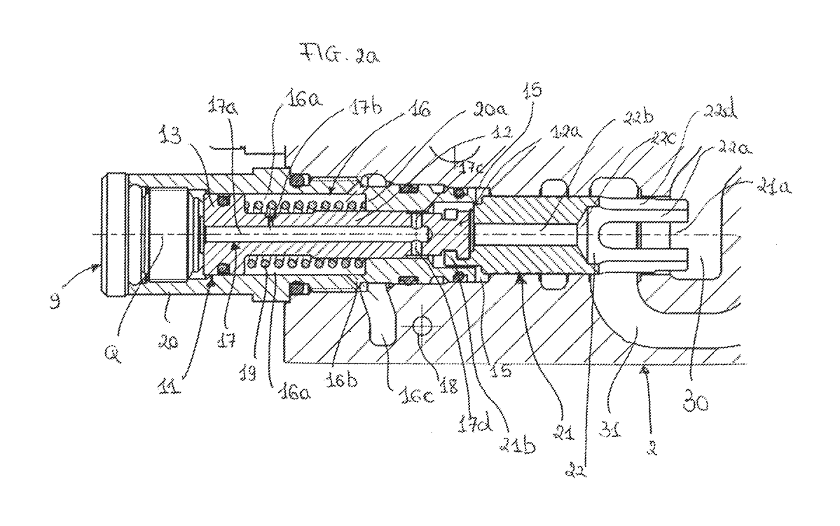

FIGS. 2a and 2b illustrate the combined “piston-flow regulating element” system of the hydraulic section of FIG. 1, in section view, in a balance condition and in a decoupling condition, respectively;

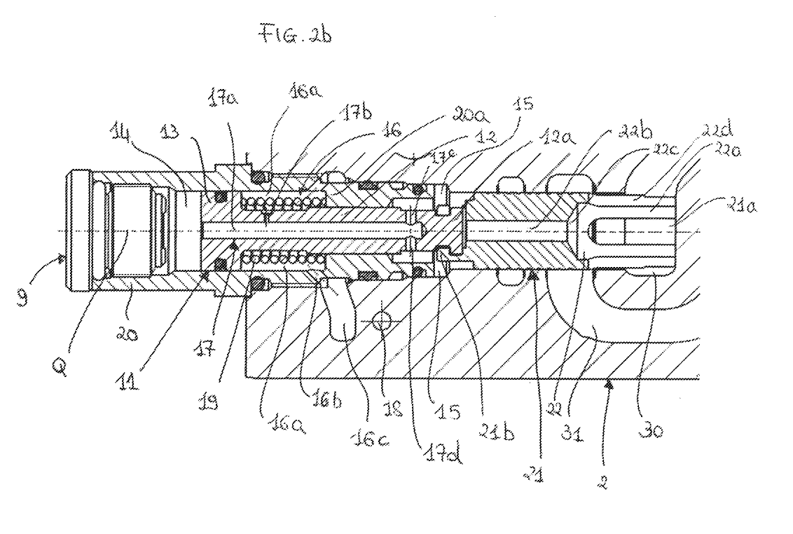

FIG. 3 illustrates an embodiment of the portion of FIG. 2a (combined “piston-flow regulating element” system), in section view;

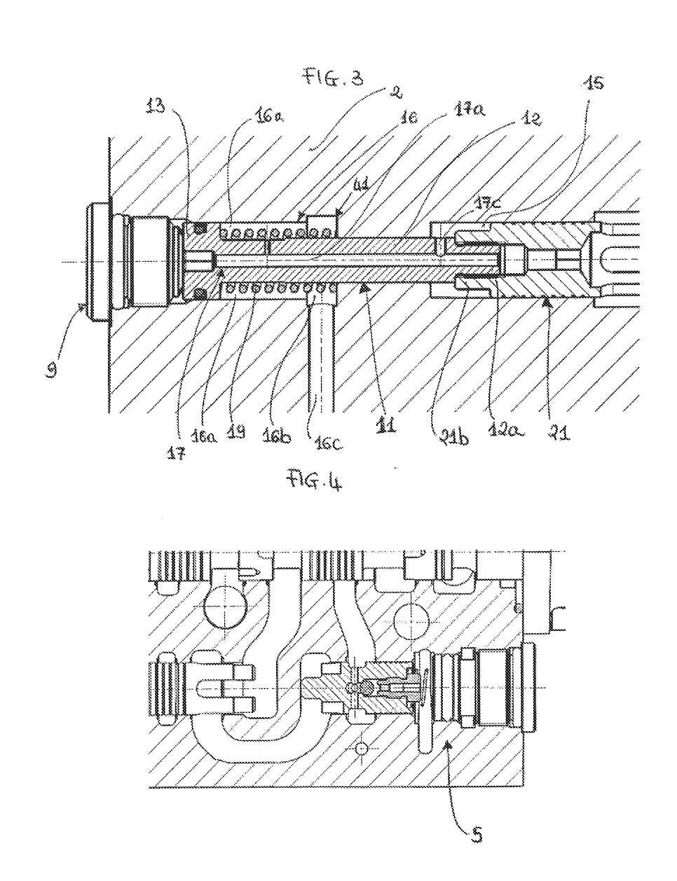

FIG. 4 illustrates the compensation means of the hydraulic section of FIG. 1, in section view;

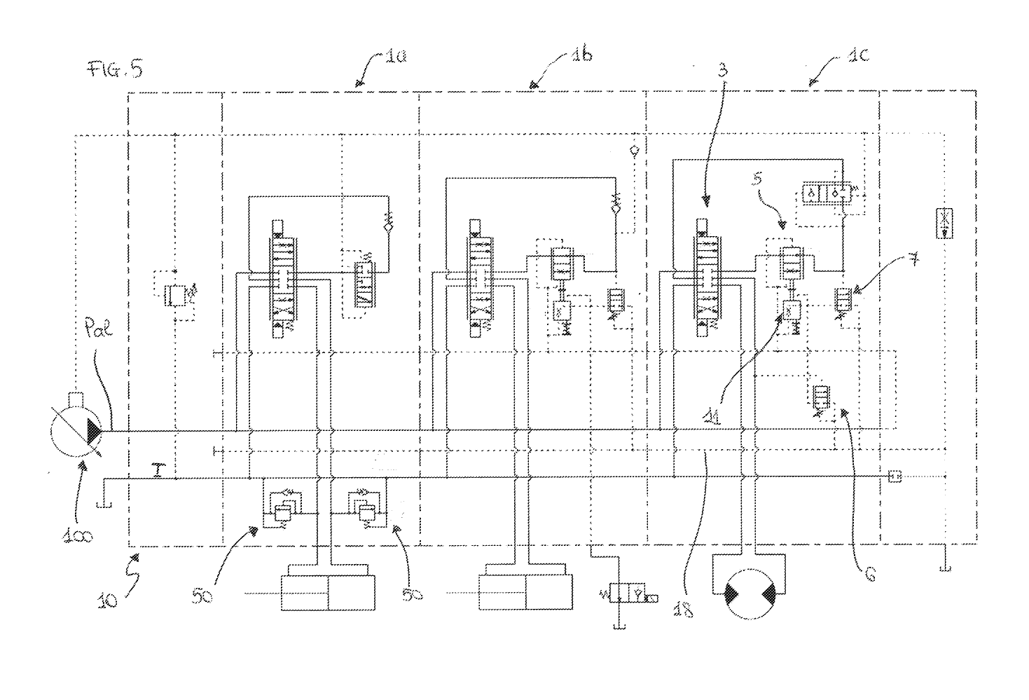

FIG. 5 illustrates the plan of a multiple hydraulic distributor, according to the present invention.

With reference to the figures, 1 indicates a hydraulic section for load-sensing applications, 10 indicates a multiple hydraulic distributor comprising a plurality of hydraulic sections 1.

Each hydraulic section 1 comprises a valve body 2 within which a main slider 3 is longitudinally slidable. Such a main slider 3 (also known as a “spool”) is used to selectively transmit hydraulic fluid under pressure coming from a supply line Pal of a pump 100 to work uses A, B through a metering orifice 4.

For example, the main spool 3 is of the six-way, three-position type. Alternatively, the main spool 3 has four positions, i.e. it envisages an additional position (called “floating” position) which drains both work uses A, B. In particular, the main spool 3 is supplied by a channel that coincides with the supply line Pal.

Upstream of the main spool 3 with respect to the flow of the hydraulic fluid pressure compensation means 5 can be found, able to maintain a substantially constant pressure drop through the metering orifice 4 or means for controlling the flow (for example a check valve).

The valve body 2 has a first hole that extends prevalently along a predefined longitudinal axis Q.

In the first hole a piston 11 (or plunger) and a flow regulating element 21 are housed. In the embodiment described and illustrated herein, the piston 11 is jointly constrained to the flow regulating element 21.

As can be seen in FIGS. 1, 2a, 2b and 3, the piston 11 has a stem 12 that extends along the predefined longitudinal axis Q.

The stem 12 originates from a base or bottom 13 having a larger cross section than the stem 12. In this context, the end of the piston 11 opposite the base 13 is called the head 12a of the piston 11.

Preferably, the flow regulating element 21 also extends along the predefined longitudinal axis Q.

The flow regulating element 21 has a first end 21a adapted to receive the hydraulic fluid coming from a front chamber 30 communicating with the metering orifice 4.

A second end 21b of the flow regulating element 21 has a recess counter-shaped to receive the head 12a of the piston 11 and define a joint therewith. In the embodiments described and illustrated herein, the counter-shaped recess is of the “T” type (known in technical English as a “T-slot”). In an alternative embodiment (not illustrated), the recess has a threaded attachment.

Preferably, the flow regulating element 21 consists of a tubular body having a variable boring. In particular, the tubular body 21 has an internal cavity 22 in which the following can be distinguished:
a first annular region 22a which extends starting from the first end 21a of the flow regulating element 21;
a second cylindrical region 22b, which extends towards the second end 21b of the flow regulating element 21 and has a smaller diameter than the external diameter of the first region 22a;
a third conical region 22c for connecting the first region 22a and the second region 22b;
a fourth region 22d, corresponding to adjustment millings (i.e. orifices) adapted to control the drop in pressure between the front chamber 30 and a first distribution bridge 31.

Preferably, the fourth region 22d is conformed like an open slot. The base 13 and the stem 12 of the piston 11 are crossed by a first through channel 17.

In the first hole, between the stem 12 of the piston 11 and the valve body 2 part of an intermediate chamber 16 is formed.

Preferably, the piston 11 is surrounded, at least partially, by a casing 20, in turn partially housed in the first hole (see FIGS. 2a-2b). The intermediate chamber 16 therefore has:
a first zone 16a afforded between the stem 12 of the piston 11 and the casing 20;
a second zone 16b afforded in the casing 20;
a third zone 16c afforded in the valve body 2.

Originally, control means 6, 7, 18 are provided, operatively active on the intermediate chamber 16 to alter its pressure so that the combined “piston-flow regulating element” system goes from a balance condition, in which the regulating element 21 is inactive therefore the front chamber 30 and the intermediate chamber 16 are at the same pressure, to a decoupling condition, in which the pressure of the front chamber 30 is decoupled from the pressure of the intermediate chamber 16. In such a condition, the regulating element 21 generates an additional drop in pressure between the front chamber 30 and the first distribution bridge 31 through the adjustment millings of the fourth region 22d, acting in fact on the residual pressure margin further altering its entity.

In particular, the control means 6, 7, 18 comprise at least one drainage channel 18 pertaining to the intermediate chamber 16.

In the embodiments described and illustrated herein, the control means 6, 7, 18 comprise two limiters 6, 7 integrated into the hydraulic section 1 and piloted by a predefined pressure. For example, such predefined pressure is taken downstream from the compensation means 5 so as to limit the power dispensed to the uses A, B according to the reaching of a predefined pressure value, in fact reducing the absorbed power and the energy dissipations. Preferably, such limiters 6, 7 are adjustable.

Alternatively, the control means comprise an external pressure tap controlled, for example, by proportional solenoid valves, or sequence valves or, however, not integrated devices, but external to the hydraulic section 1.

Preferably, the casing 20 has an open end adapted to receive a closing plug 9.

Between the closing plug 9, the base 13 of the piston 11 and the inner walls of the casing 20, a rear chamber 14 is defined.

The rear chamber 14 is placed in communication with the intermediate chamber 16 through the first through channel 17.

Preferably, the first through channel 17 made in the piston 11 comprises:
a first portion 17a having a substantially longitudinal extension within the stem 12 and open on the base 13 of the piston 11;
a second portion 17b that branches off from the first portion 17a and leads into the intermediate chamber 16, in particular into the first zone 16a of the intermediate chamber 16.

In particular, the second portion 17b has a substantially transversal extension in the stem 12 of the piston 11.

Preferably, the second portion 17b is shaped and sized so as to constitute a flow restrictor. More preferably, the second portion 17b is a fixed metering orifice.

Preferably, the first portion 17a of the first through channel 17 is coaxial to the stem 12 of the piston 11.

The first through channel 17 comprises two further portions 17c, 17d, pertaining to the first portion 17a. In particular, the further portions 17c, 17b have a substantially transversal extension in the stern 12 of the piston 11.

As can be seen from FIG. 2a, such further portions 17c, 17d lead into a front chamber 15 defined between the casing 20, the head 12a of the piston 11 and the second end 21b of the flow regulating element 21.

One embodiment envisages a pre-established pressure being externally settable in the intermediate chamber 16. In that case, the flow restrictor 17b is not present. Preferably, the pre-established pressure is variable. In the embodiments described and illustrated herein, a first spring 19 is housed in the intermediate chamber 16.

In particular, the first spring 19 abuts between the base 13 of the piston 11 and a front portion 20a of the casing 20. Such first spring 19 allows the combined “piston-flow regulating element” system to be kept in the balance condition with the regulator inactive (with flow regulation inactive) until a pressure imbalance intervenes due to the discharge of fluid, for example in the drainage channel 18.

The embodiment just described, employing the first spring 19, is the preferred embodiment. In fact, the first spring 19 allows the system to be re-equipped once the pressure balance in the chambers has been re-established, by repositioning the combined “piston-flow regulating element” system so that the intervention of the adjustment millings of the fourth region 22d is made ineffective on the residual pressure margin.

However, an embodiment is envisaged in which the first spring is not present.

In one embodiment, illustrated in FIG. 3, the piston 11 is directly housed in the first hole, i.e. the casing 20 is not present. In that case, the valve body 2 is appropriately shaped so as to define an abutment element 41 for the first spring 19. In that case, in fact, the first spring 19 abuts between the base 13 of the piston 11 and such abutment element 41 of the valve body 2.

In such an embodiment, the intermediate chamber 16 has:
a first zone 16a obtained between the stem 12 of the piston 11 and the valve body 2;
a second zone 16b and a third zone 16c obtained in the valve body 2.

In such an embodiment, the rear chamber 14 is defined between the closing plug 9, the base 13 of the piston 11 and the walls of the valve body 2 delimiting the first hole.

In such an embodiment, the front chamber 15 is defined between the head 12a of the piston 11, the second end 21b of the flow regulating element 21 and the inner walls of the valve body 2 delimiting the first hole.

In the embodiment of FIG. 3, the head 12a of the piston 11 has an outer thread adapted to engage by screwing with the inner thread of the second end 21b of the flow regulating element 21.

In the embodiment of FIG. 4, note that the valve body 2 has a second hole in which the compensation means 5 or flow control means are housed. Advantageously, the first hole and the second hole are distinct and obtained alongside of each other.

In the embodiments described and illustrated herein, the second hole also extends along the predefined longitudinal axis Q.

Preferably, the compensation means 5 comprise a flow-sharing or priority compensator (see for example FIG. 4).

For example, the compensator 5 has a post-compensated architecture of the known type, therefore it will not be described further.

Alternatively, the compensator 5 is of the differential area type, as illustrated in FIGS. 2a-2b or 4a-4b of European patent application no. 14158991.1.

Alternatively, as already mentioned above, means for controlling the flow with check valves are provided.

In one embodiment (not illustrated), the piston 11 and the flow regulating element 21 are unrestricted, preferably with the interposition of a second spring, for example, housed in the internal cavity 22 of the regulating element 21.

The hydraulic distributor of FIG. 5 comprises:
a flow-sharing section of the known type, indicated with number 1a;
a non-compensated section according to the present invention, indicated with number 1b;
a flow-sharing section, according to the present invention, indicated with number 1c.

All the sections 1a, 1b, 1c are crossed at least by the supply line Pal and by a drainage line T. Preferably, all the sections 1a, 1b, 1c are also crossed by the drainage channel 18.

The flow-sharing section 1a of the known type will not be described since it does not constitute the subject matter of the present invention. It is worth highlighting however that in the flow-sharing section 1a of the known type, the limiting function is entrusted to auxiliary valves 50 on the uses A, B with high energy dissipation.

The flow-sharing section with a differential piston 1b is described in pages 5 to 10 (document originally filed in Italian) and illustrated in FIGS. 1, 2a and 2b of European patent application no. 14158991,1, filed on Nov. 3, 2014 by the Applicant.

The limiters 6, 7 are made like the pilot stage of FIG. 5 of European patent application no. 14158991.1. Such pilot stage is described on page 11 of European patent application no. 14158991.1 (document originally filed in Italian).

The operation of the hydraulic section proposed is described below.

The main spool 3 can slide in the valve body 2 between a neutral position, in which it blocks the passage of fluid towards the front chamber 30, and an operative position in which it enables the passage of hydraulic fluid under pressure coming from the supply line Pal towards the first chamber 30 through the metering orifice 4.

The pressure present in the front chamber 30 is transmitted to the front chamber 15 through the internal cavity 22 of the flow regulating element 21.

From the front chamber 15, the pressure is transmitted to the intermediate chamber 16 through the two further portions 17c, 17d, the first portion 17a and the flow restrictor 17b of the first through channel 17.

Still through the first through channel 17, the pressure also reaches the rear chamber 14.

In that way, the combined “piston-flow regulating element” system can be found in the balance condition previously described therefore the flow regulation is inhibited.

In this condition, the fluid passes from the front chamber 30 to the first distribution bridge 31 pertaining to the compensator 5 without being subject to additional pressure drops with respect to the normal passing load loss.

By conditioning the pressure in the intermediate chamber 16, for example through the drainage channel 18, the combined “piston-flow regulating element” system is brought into the decoupling condition, therefore the pressure of the front chamber 30 is decoupled from the pressure of the intermediate chamber 16. In this condition, the adjustment millings of the fourth region 22d generate an additional load loss which, by altering the residual pressure margin, results into a corresponding variation in flow dispensed to the users.

The characteristics of the hydraulic section for load sensing applications and the multiple hydraulic distributor, according to the present invention, are clear, as are the advantages.

In particular, the combined “piston-flow regulating element” system, housed in the same hole, allows the flow made available to the users to be regulated according to external signals (for example alarms) or internal signals (e.g. work pressure beyond which there is a risk of the machine overturning therefore the movement must be slowed down). In fact, the combined “piston-flow regulating element” system acts directly on the residual pressure margin and does not influence the action of the compensator.

In that way, in the hypothesis of proportional pressure control in the differential chamber, infinite speeds can be generated for the functions actuated by the hydraulic section.

Since the proposed solution is based on the alteration of the balance of pressure on the active areas of the differential pressure, the hydraulic section proposed is compact and structurally simple.

Furthermore, the solution proposed responds to the requirement to create hydraulic sections as modular as possible, in order to be able to equip them with the necessary functions through simple component replacement, leaving the housings unvaried and enabling/disabling some paths of fluid.

1. Hydraulic section (1) for use in a hydraulic distributor (10) comprising:
a valve body (2);
a main spool (3) longitudinally slidable within said valve body (2) to selectively transmit the hydraulic fluid under pressure coming from a supply line (Pal) of a pump (100) to work uses (A, B) through a metering orifice (4),
characterised in that it comprises:
a first hole obtained in said valve body (2) and extending prevalently along a predefined longitudinal axis (Q);
a piston (11) housed in said first hole and comprising a base (13), a stem (12) originating from the base (13) and extending along said predefined longitudinal axis (Q) and a head (12a);
a flow regulating element (21) adapted to receive the hydraulic fluid coming from a front chamber (30) communicating with said metering orifice (4), said flow regulating element (21) being housed in said first hole and extending along said predefined longitudinal axis (Q), said piston (11) having a head (12a) of the stem (12) engaged in the flow regulating element (21);
an intermediate chamber (16) extending at least partially into said first hole and delimited by the stem (12) of the piston (11);
control means (6, 7, 18) operatively active on said intermediate chamber (16) to alter its pressure so that the combined piston (11)—regulating element (21) system goes from a balance condition, in which said regulating element (21) is inactive, to a decoupling condition, in which the pressure of said front chamber (30) is decoupled from the pressure of said intermediate chamber (16), said regulating element (21) having adjustment millings (22d) configured to control the pressure drop between said front chamber (30) and a first distribution bridge (31) so as to generate an additional pressure drop between said front chamber (30) and said distribution bridge (31).

2. Hydraulic section (1) according to claim 1, further comprising a second hole obtained in said valve body (2) to house pressure compensation means (5) or flow control means.

3. Hydraulic section (1) according to claim 1, further comprising pressure compensation means (5) of the flow-sharing or priority type.

4. Hydraulic section (1) according to claim 1, wherein said control means (6, 7, 18) comprise at least one drainage channel (18) pertaining to said intermediate chamber (16).

5. Hydraulic section (1) according to claim 1, further comprising a casing (20) situated in said first hole and at least partially surrounding said piston (11), said intermediate chamber (16) comprising:
a first zone (16a) obtained between the stem (12) of the piston (11) and said casing (20);
a second zone (16b) obtained in the casing (20) itself;
a third zone (16c) obtained in the valve body (2).

6. Hydraulic section (1) according to claim 5, further comprising:
a closing plug (9) of said first hole;
a rear chamber (14) defined between the closing plug (9), the base (13) of the piston (11) and said casing (20);
a front chamber (15) defined between the head (12a) of said piston (11), said flow restrictor (21) and said casing (20);
a first through channel (17) made in the stem (12) of the piston (11) to place the intermediate chamber (16) in communication with the rear chamber (14) and the front chamber (15).

7. Hydraulic section (1) according to claim 6, wherein said first through channel (17) comprises a first portion (17a) having a substantially longitudinal extension within the stem (12) of said piston (11) and open on the base (13) of the piston (11) itself, and a second portion (17b) that branches off from said first portion (17a) and leads into the intermediate chamber (16).

8. Hydraulic section (1) according to claim 7, wherein said second portion (17b) is shaped and sized so as to constitute a flow restrictor.

9. Hydraulic section (1) according to claim 1, further comprising a first spring (19) housed in said intermediate chamber (16).

10. Hydraulic section (1) according to claim 1, wherein said counter-shaped recess is a “T-slot”.
